(19) United States
(12) Patent Application Publication
(10) Pub. No.: US 2024/0120876 A1
(43) Pub. Date: Apr. 11, 2024

(54) PHOTOVOLTAIC SYSTEMS ON ROOF PLANES

(71) Applicant: GAF Energy LLC, Parsippany, NJ (US)

(72) Inventors: Gabriela Bunea, San Jose, CA (US); Dan Hua, San Jose, CA (US)

(21) Appl. No.: 18/472,856

(22) Filed: Sep. 22, 2023

Related U.S. Application Data
(60) Provisional application No. 63/414,793, filed on Oct. 10, 2022.

(51) Int. Cl. H02S 20/25

(52) U.S. Cl. CPC H02S 20/25

(57) ABSTRACT

A system includes a roof deck with sloped roof planes, including a first roof plane having a first surface area, a second roof plane having a second surface area, and a third roof plane with a third surface area. The second roof plane is different from the first roof plane, and the third roof plane is different from the first roof plane and the second roof plane. A plurality of photovoltaic modules is installed on the first surface area of the first roof plane, a plurality of first roofing shingles, each of which do not include a solar cell and composed of at least a first material, is installed on the second surface area of the second roof plane, and plurality of second roofing shingles, each of which is composed of at least a second material, is installed on the third surface area of the third roof plane.

### CROSS-REFERENCE TO RELATED APPLICATION

This application is a Section 111(a) application relating to and claiming the benefit of commonly owned, co-pending U.S. Provisional Patent Application Ser. No. 63/414,793, filed Oct. 10, 2022, entitled “PHOTOVOLTAIC SYSTEMS ON ROOF PLANES,” the contents of which is incorporated herein by reference in its entirety.

### FIELD OF THE INVENTION

The present invention relates to photovoltaic systems and, more particularly, photovoltaic systems integrated on roof planes of a building structure.

### BACKGROUND

Photovoltaic systems are installed on building roofs to generate electricity.

### SUMMARY

A system includes a roof deck, wherein the roof deck includes a plurality of sloped roof planes, wherein the plurality of sloped roof planes includes a first roof plane, wherein the first roof plane includes a first surface area, and a second roof plane, wherein the second roof plane includes a second surface area, wherein the second roof plane is different from the first roof plane, and a third roof plane, wherein the third roof plane includes a third surface area, wherein the third roof plane is different from the first roof plane and the second roof plane; a plurality of photovoltaic modules installed on the first surface area of the first roof plane; a plurality of first roofing shingles, wherein each of the plurality of first roofing shingles does not include a solar cell, wherein each of the plurality of first roofing shingles is composed of at least a first material, wherein the plurality of first roofing shingles is installed on the second surface area of the second roof plane; and a plurality of second roofing shingles, wherein each of the plurality of second roofing shingles is composed of at least a second material, wherein the second material is different from the first material, and wherein the plurality of second roofing shingles is installed on the third surface area of the third roof plane.

In some embodiments, an appearance of the plurality of first roofing shingles aesthetically matches an appearance of the plurality of photovoltaic modules when viewed from a vantage point located at a ground level of a structure comprising the roof deck, and wherein an appearance of the plurality of second roofing shingles aesthetically matches the appearance of the plurality of first roofing shingles and the appearance of the plurality of photovoltaic modules when viewed from the vantage point. In some embodiments, the plurality of photovoltaic modules is installed on substantially an entirety of the first surface area of the first roof plane, and wherein the plurality of first roofing shingles is installed on substantially an entirety of the second surface area of the second roof plane.

In some embodiments, each of the plurality of first roofing shingles includes a first layer, wherein the first layer includes a first surface, and a second surface opposite the first surface, wherein the first surface is textured, and a second layer, wherein the second layer is below the second surface of the first layer. In some embodiments, each of the plurality of photovoltaic modules includes at least one solar cell, an encapsulant encapsulating the at least one solar cell, wherein the encapsulant of the photovoltaic module includes a first surface and a second surface opposite the first surface of the encapsulant of the photovoltaic module, a frontsheet, wherein the frontsheet includes a first surface, and a second surface opposite the first surface of the frontsheet, wherein the second surface of the frontsheet is juxtaposed with the first surface of the encapsulant, and a backsheet juxtaposed with the second surface of the encapsulant of the photovoltaic module.

In some embodiments, the first surface of the frontsheet is textured. In some embodiments, each of the first layer and the second layer is composed of a polymer. In some embodiments, each of the first layer and the second layer is composed of thermoplastic polyolefin (TPO). In some embodiments, each of the first layer and the second layer includes continuous fiber thermoplastic composite tape (CFT). In some embodiments, the first layer has a thickness of 25 mils to 100 mils. In some embodiments, the second layer has a thickness of 25 mils to 200 mils. In some embodiments, the first layer includes a pattern printed on the first surface of the first layer. In some embodiments, the pattern is a depiction of solar cells.

In some embodiments, the first roof plane is located at a first elevation, wherein the first elevation is measured relative to a ground level of a structure comprising the roof deck, and wherein the second roof plane is located at a second elevation, wherein the second elevation is measured relative to the ground level, and wherein the first elevation is different than the second elevation. In some embodiments, the first roof plane includes a first edge and a second edge opposite the first edge, wherein the second roof plane includes a first edge and a second edge opposite the first edge of the second roof plane, wherein the first edge of the first roof plane is substantially parallel with the first edge of the second roof plane, and wherein the second edge of the first roof plane is substantially parallel with the second edge of the second roof plane.

In some embodiments, the first roof plane includes a first edge and a second edge opposite the first edge, wherein the second roof plane includes a first edge and a second edge opposite the first edge of the second roof plane, wherein the first edge of the first roof plane is oblique relative to the first edge of the second roof plane, and wherein the second edge of the first roof plane is oblique relative to the second edge of the second roof plane. In some embodiments, the first material is asphalt, metal, a polymer or rubber. In some embodiments, the second material is asphalt, metal, a polymer or rubber.

In some embodiments, a system includes a roof deck, wherein the roof deck includes a plurality of sloped roof planes, wherein the plurality of sloped roof planes includes a first roof plane, wherein the first roof plane includes a first surface area, and a second roof plane, wherein the second roof plane includes a second surface area, wherein the second roof plane is different from the first roof plane; a plurality of photovoltaic modules installed on the first surface area of the first roof plane; a plurality of first roofing shingles, wherein each of the plurality of first roofing shingles does not include a solar cell, wherein each of the plurality of first roofing shingles is composed of at least a first material, wherein the plurality of first roofing shingles is installed on the first surface area of the first roof plane; and a plurality of second roofing shingles, wherein each of the plurality of second roofing shingles is composed of a second material, wherein the second material is different than the first material, and wherein the plurality of second roofing shingles is installed on the second surface area of the second roof plane.

In some embodiments, a method includes the steps of installing a plurality of photovoltaic modules on a roof deck, wherein the roof deck includes a plurality of sloped roof planes, wherein the plurality of sloped roof planes includes a first roof plane, wherein the first roof plane includes a first surface area, and a second roof plane, wherein the second roof plane includes a second surface area, wherein the second roof plane is different from the first roof plane, and a third roof plane, wherein the third roof plane includes a third surface area, wherein the third roof plane is different from the first roof plane and the second roof plane, wherein the plurality of photovoltaic modules is installed on the first surface area of the first roof plane; installing a plurality of first roofing shingles on the second surface area of the second roof plane, wherein each of the plurality of first roofing shingles does not include a solar cell wherein each of the plurality of first roofing shingles is composed of at least a first material; and installing a plurality of second roofing shingles on the third surface area of the third roof plane, wherein each of the plurality of second roofing shingles is composed of at least a second material, and wherein the second material is different than the first material.

### BRIEF DESCRIPTION OF THE DRAWINGS

FIGS. 1A and 1B are a top plan view and side elevational view, respectively, of some embodiments of a photovoltaic module;

FIGS. 2 and 3 are schematic views of some embodiments of a photovoltaic module;

FIGS. 4 through 6 show some embodiments of a roofing shingle; and

FIGS. 7 through 9 show some embodiments of a roofing system on a roof deck of a structure.

### DETAILED DESCRIPTION

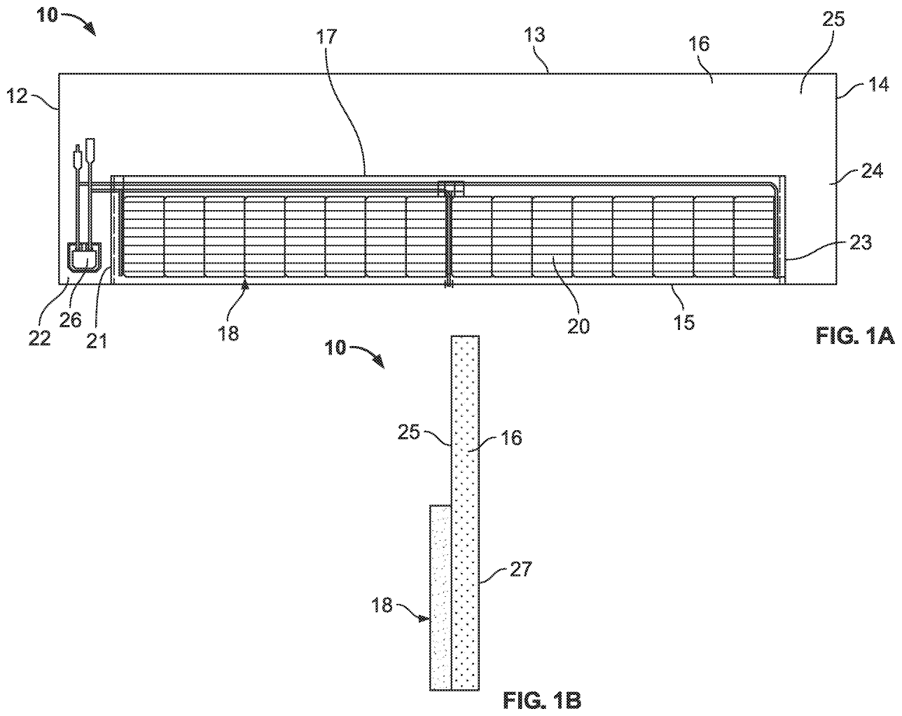

Referring to FIGS. 1A and 1B, in some embodiments, a photovoltaic module 10 includes a first end 12, a second end 14 opposite the first end 12, a first edge 13 extending from the first end 12 to the second end 14, and a second edge 15 opposite the first edge 13 and extending from the first end 12 to the second end 14. In some embodiments, the photovoltaic module 10 includes a headlap portion 16. In some embodiments, the headlap portion 16 extends from the first end 12 to the second end 14 and from the first edge 13 to a first location 17 between the first edge 13 and the second edge 15. In some embodiments, the photovoltaic module 10 includes a reveal portion 18. In some embodiments, the reveal portion 18 includes at least one solar cell 20. In some embodiments, the photovoltaic module 10 includes a first side lap 22 located at the first end 12. In some embodiments, the first side lap 22 includes a length extending from the first end 12 to a second location 21 between the first end 12 and the second end 14. In some embodiments, the photovoltaic module 10 includes a second side lap 24 located at the second end 14. In some embodiments, the second side lap 24 includes a length extending from the second end 14 to a third location 23 between the first end 12 and the second end 14. In some embodiments, the photovoltaic module 10 includes an outer surface 25 and an inner surface 27 opposite the outer surface 25. In some embodiments, the reveal portion 18 extends from the first side lap 22 to the second side lap 24 and from the second edge 15 to the first location 17. In some embodiments, the photovoltaic module 10 is configured to be installed on a building structure. In some embodiments, the photovoltaic module 10 is configured to be installed on an exterior wall of a building structure as described in further detail below. In some embodiments, at least one junction box 26 is located on the first side lap 22. In some embodiments, the at least one junction box 26 includes a plurality of the junction boxes 26. In some embodiments, the photovoltaic module 10 includes a structure, composition, components, and/or function similar to those of one or more embodiments of the photovoltaic modules disclosed in PCT International Patent Publication No. WO 2022/051593, Application No. PCT/US2021/049017, published Mar. 10, 2022, entitled Building Integrated Photovoltaic System, owned by GAF Energy LLC, and U.S. Pat. No. 11,251,744 to Bunea et al., issued Feb. 15, 2022, entitled “Photovoltaic Shingles and Methods of Installing Same,” the contents of each of which are incorporated by reference herein in its entirety.

In some embodiments, the at least one solar cell 20 includes a plurality of the solar cells 20. In some embodiments, the plurality of solar cells 20 includes two solar cells. In some embodiments, the plurality of solar cells 20 includes three solar cells. In some embodiments, the plurality of solar cells 20 includes four solar cells. In some embodiments, the plurality of solar cells 20 includes five solar cells. In some embodiments, the plurality of solar cells 20 includes six solar cells. In some embodiments, the plurality of solar cells 20 includes seven solar cells. In some embodiments, the plurality of solar cells 20 includes eight solar cells. In some embodiments, the plurality of solar cells 20 includes nine solar cells. In some embodiments, the plurality of solar cells 20 includes ten solar cells. In some embodiments, the plurality of solar cells 20 includes eleven solar cells. In some embodiments, the plurality of solar cells 20 includes twelve solar cells. In some embodiments, the plurality of solar cells 20 includes thirteen solar cells. In some embodiments, the plurality of solar cells 20 includes fourteen solar cells. In some embodiments, the plurality of solar cells 20 includes fifteen solar cells. In some embodiments, the plurality of solar cells 20 includes sixteen solar cells. In some embodiments, the plurality of solar cells 20 includes more than sixteen solar cells.

In some embodiments, the plurality of solar cells 20 is arranged in one row (i.e., one reveal). In another embodiment, the plurality of solar cells 20 is arranged in two rows (i.e., two reveals). In another embodiment, the plurality of solar cells 20 is arranged in three rows (i.e., three reveals). In another embodiment, the plurality of solar cells 20 is arranged in four rows (i.e., four reveals). In another embodiment, the plurality of solar cells 20 is arranged in five rows (i.e., five reveals). In another embodiment, the plurality of solar cells 20 is arranged in six rows (i.e., six reveals). In other embodiments, the plurality of solar cells 20 is arranged in more than six rows. In some embodiments, the at least one solar cell 20 is electrically inactive (i.e., a “dummy” solar cell).

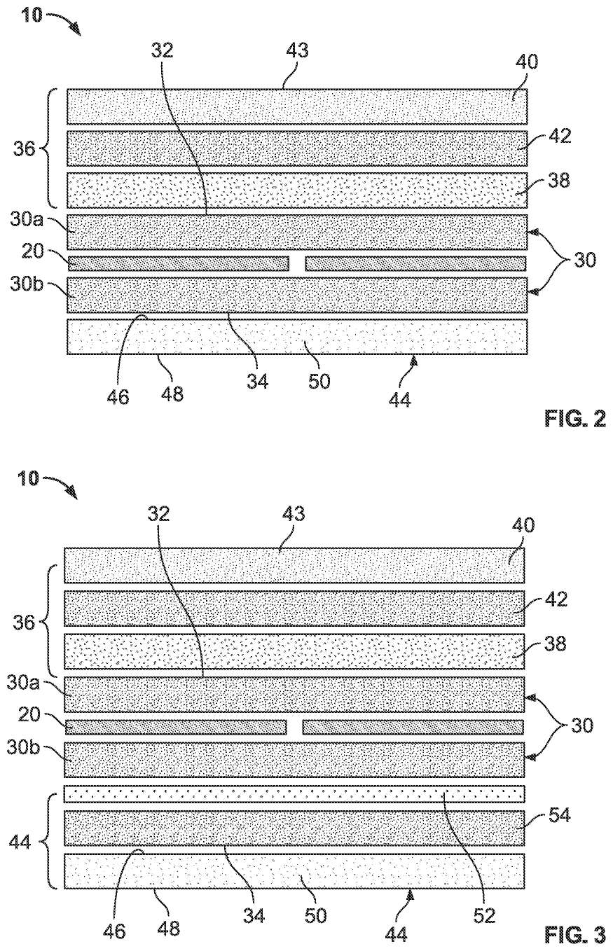

Referring to FIGS. 2 and 3, in some embodiments, the photovoltaic module 10 includes an encapsulant 30 encapsulating the at least one solar cell 20. In some embodiments, the encapsulant 30 includes a first layer 30a having a first surface 32 and a second layer 30b having a second surface 34 opposite the first surface 32. In some embodiments, the photovoltaic module 10 includes a frontsheet 36 juxtaposed with the first surface 32 of the first layer 30a of the encapsulant 30. In some embodiments, the frontsheet 36 includes a glass layer 38. In some embodiments, the frontsheet 36 includes a polymer layer 40 attached to the glass layer 38. In some embodiments, the polymer layer 40 forms an upper surface of the photovoltaic module 10. In some embodiments, the polymer layer 40 is attached to the glass layer 38 by a first adhesive layer 42. In some embodiments, an upper surface 43 of the polymer layer 40 is an upper surface of the photovoltaic module 10. In some embodiments, the upper surface 43 of the polymer layer 40 is textured. In some embodiments, the upper surface 43 of the polymer layer 40 is embossed. In some embodiments, the upper surface 43 of the polymer layer 40 is embossed with a plurality of indentations. In some embodiments, the upper surface 43 of the polymer layer 40 includes a pattern. In some embodiments, the upper surface 43 of the polymer layer 40 includes a printed pattern. In some embodiments, the upper surface 43 of the polymer layer 40 includes an embossed pattern. In some embodiments, the upper surface 43 of the polymer layer 40 includes a textured pattern.

In some embodiments, the photovoltaic module 10 includes a backsheet 44. In some embodiments, the backsheet 44 is juxtaposed with the second surface 34 of the second layer 30b of the encapsulant 30. In some embodiments, the backsheet 44 includes a first surface 46 and a second surface 48 opposite the first surface 46 of the backsheet 44. In some embodiments, the second surface 48 of the backsheet 44 forms a lower surface of the photovoltaic module 10. In some embodiments, the backsheet 44 includes a first layer 50. In some embodiments, the backsheet 44 includes a second layer 52 (see FIG. 3). In some embodiments, the second layer 52 is attached to the first layer 50 by a second adhesive layer 54. In some embodiments, the backsheet 44 includes only one layer (see FIG. 2). In some embodiments, the backsheet 44 includes only the first layer 50 (see FIG. 2). In some embodiments, the backsheet 44 does not include the second layer 52 (see FIG. 2). In some embodiments, the backsheet 44 is composed of a polymer. In some embodiments, the backsheet 44 is composed of thermoplastic polyolefin (TPO). In some embodiments, the backsheet 44 forms the headlap portion 16.

In some embodiments, each of the encapsulant 30, the frontsheet 36, including each of the glass layer 38, the polymer layer 40, and the first adhesive layer 42, and the backsheet 44, including the first layer 50, the second layer 52, and the second adhesive layer 54 of the photovoltaic module 10, as applicable, includes a structure, composition and/or function of similar to those of more or one of the embodiments of the corresponding components disclosed in PCT International Patent Publication No. WO 2022/051593, Application No. PCT/US2021/049017, published Mar. 10, 2022, entitled Building Integrated Photovoltaic System, owned by GAF Energy LLC, and U.S. Pat. No. 11,251,744 to Bunea et al., issued Feb. 15, 2022, entitled “Photovoltaic Shingles and Methods of Installing Same,” the contents of each of which are incorporated by reference herein in its entirety.

In some embodiments, the photovoltaic module 10 includes a structure, composition, components, and/or function similar to those of one or more embodiments of the photovoltaic roofing shingles disclosed in U.S. application Ser. No. 17/831,307, filed Jun. 2, 2022, titled “Roofing Module System,” and published under U.S. Patent Application Publication No. 2022-0393637 on Dec. 8, 2022; and/or U.S. application Ser. No. 18/169,718, filed Feb. 15, 2023, titled “Roofing Module System,” and published under U.S. Patent Application Publication No. 2023-0203815 on Jun. 29, 2023, the contents of each of which are incorporated by reference herein in its entirety.

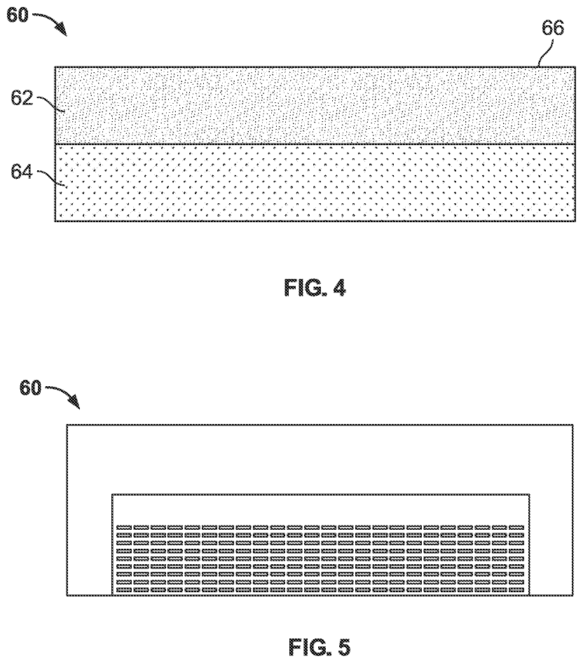

FIGS. 4 and 5 show an embodiment of a roofing shingle 60. In some embodiments, the roofing shingle 60 includes a first layer 62 and a second layer 64. In some embodiments, the first layer 62 overlays the second layer 64. In some embodiments, the first layer 62 is juxtaposed with the second layer 64. In some embodiments, the first layer 62 and the second layer 64 are thermally bonded to one another. In some embodiments, the first layer 62 and the second layer 64 are laminated. In some embodiments, the first layer 62 is attached to the second layer 64 by and adhesive. In some embodiments, the first layer 62 and the second layer 64 are mechanically attached to one another. In some embodiments, the roofing shingle 60 does not include a solar cell, a photovoltaic cell, or any electrical device that converts the energy of light into electricity. In some embodiments, the roofing shingle 60 does not include any electrically active components.

In some embodiments, the first layer 62 is composed of a polymeric material. In some embodiments, the first layer 62 is composed of polyethylene terephthalate (“PET”). In another embodiment, the first layer 62 is composed of ethylene tetrafluoroethylene (“ETFE”). In some embodiments, the first layer 62 is composed of an acrylic such as polymethyl methacrylate (“PMMA”). In some embodiments, the first layer 62 is composed of thermoplastic polyolefin (TPO). In some embodiments, the first layer 62 is composed of a single ply TPO roofing membrane. In other embodiments, non-limiting examples of TPO membranes are disclosed in U.S. Pat. No. 9,359,014 to Yang et al., which is incorporated by reference herein in its entirety. In another embodiment, the first layer 62 is composed of includes polyvinyl chloride. In some embodiments, the first layer 62 is composed of ethylene propylene diene monomer (EPDM) rubber. In some embodiments, the first layer 62 is includes a flame retardant additive. In some embodiments, the flame retardant additive may be clays, nanoclays, silicas, carbon black, metal hydroxides such as aluminum hydroxide, metal foils, graphite, and combinations thereof. In some embodiments, the first layer 62 is composed of a UV resistant material. In some embodiments, the first layer 62 includes a UV resistant coating. In some embodiments, the first layer 62 is composed of a water resistant material.

In some embodiments, the second layer 64 is composed of a polymeric material. In some embodiments, the second layer 64 is composed of polyethylene terephthalate (“PET”). In another embodiment, the second layer 64 is composed of ethylene tetrafluoroethylene (“ETFE”). In some embodiments, the second layer 64 is composed of an acrylic such as polymethyl methacrylate (“PMMA”). In some embodiments, the second layer 64 is composed of thermoplastic polyolefin (TPO). In some embodiments, the second layer 64 is composed of a single ply TPO roofing membrane. In other embodiments, non-limiting examples of TPO membranes are disclosed in U.S. Pat. No. 9,359,014 to Yang et al., which is incorporated by reference herein in its entirety. In another embodiment, the second layer 64 is composed of includes polyvinyl chloride. In some embodiments, the second layer 64 of ethylene propylene diene; monomer (EPDM) rubber. In some embodiments, the second layer 64 includes a flame retardant additive. In some embodiments, the flame retardant additive may be clays, nanoclays, silicas, carbon black, metal hydroxides such as aluminum hydroxide, metal foils, graphite, and combinations thereof. In some embodiments, the second layer 64 is composed of a UV resistant material. In some embodiments, the second layer 64 is composed of a water resistant material. In some embodiments, the second layer 64 is composed of a polymer with fiberglass.

In some embodiments, the first layer 62 has a thickness of 25 mils to 100 mils. In some embodiments, the first layer 62 has a thickness of 25 mils to 90 mils. In some embodiments, the first layer 62 has a thickness of 25 mils to 80 mils. In some embodiments, the first layer 62 has a thickness of 25 mils to 70 mils. In some embodiments, the first layer 62 has a thickness of 25 mils to 60 mils. In some embodiments, the first layer 62 has a thickness of 25 mils to 50 mils. In some embodiments, the first layer 62 has a thickness of 25 mils to 40 mils. In some embodiments, the first layer 62 has a thickness of 25 mils to 30 mils. In some embodiments, the first layer 62 has a thickness of 30 mils to 100 mils. In some embodiments, the first layer 62 has a thickness of 30 mils to 90 mils. In some embodiments, the first layer 62 has a thickness of 30 mils to 80 mils. In some embodiments, the first layer 62 has a thickness of 30 mils to 70 mils. In some embodiments, the first layer 62 has a thickness of 30 mils to 60 mils. In some embodiments, the first layer 62 has a thickness of 30 mils to 50 mils. In some embodiments, the first layer 62 has a thickness of 30 mils to 40 mils.

In some embodiments, the first layer 62 has a thickness of 40 mils to 100 mils. In some embodiments, the first layer 62 has a thickness of 40 mils to 90 mils. In some embodiments, the first layer 62 has a thickness of 40 mils to 80 mils. In some embodiments, the first layer 62 has a thickness of 40 mils to 70 mils. In some embodiments, the first layer 62 has a thickness of 40 mils to 60 mils. In some embodiments, the first layer 62 has a thickness of 40 mils to 50 mils. In some embodiments, the first layer 62 has a thickness of 50 mils to 100 mils. In some embodiments, the first layer 62 has a thickness of 50 mils to 90 mils. In some embodiments, the first layer 62 has a thickness of 50 mils to 80 mils. In some embodiments, the first layer 62 has a thickness of 50 mils to 70 mils. In some embodiments, the first layer 62 has a thickness of 50 mils to 60 mils.

In some embodiments, the first layer 62 has a thickness of 60 mils to 100 mils. In some embodiments, the first layer 62 has a thickness of 60 mils to 90 mils. In some embodiments, the first layer 62 has a thickness of 60 mils to 80 mils. In some embodiments, the first layer 62 has a thickness of 60 mils to 70 mils. In some embodiments, the first layer 62 has a thickness of 70 mils to 100 mils. In some embodiments, the first layer 62 has a thickness of 70 mils to 90 mils. In some embodiments, the first layer 62 has a thickness of 70 mils to 80 mils. In some embodiments, the first layer 62 has a thickness of 80 mils to 100 mils. In some embodiments, the first layer 62 has a thickness of 80 mils to 90 mils. In some embodiments, the first layer 62 has a thickness of 90 mils to 100 mils.

In some embodiments, the first layer 62 has a thickness of 25 mils. In some embodiments, the first layer 62 has a thickness of 30 mils. In some embodiments, the first layer 62 has a thickness of 40 mils. In some embodiments, the first layer 62 has a thickness of 50 mils. In some embodiments, the first layer 62 has a thickness of 60 mils. In some embodiments, the first layer 62 has a thickness of 70 mils. In some embodiments, the first layer 62 has a thickness of 80 mils. In some embodiments, the first layer 62 has a thickness of 90 mils. In some embodiments, the first layer 62 has a thickness of 100 mils.

In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 25 mils to 200 mils. In some embodiments, the second layer 64 has a thickness of 40 mils to 200 mils. In some embodiments, the second layer 64 has a thickness of 40 mils to 190 mils. In some embodiments, the second layer 64 has a thickness of 40 mils to 180 mils. In some embodiments, the second layer 64 has a thickness of 40 mils to 170 mils. In some embodiments, the second layer 64 has a thickness of 40 mils to 160 mils. In some embodiments, the second layer 64 has a thickness of 40 mils to 150 mils. In some embodiments, the second layer 64 has a thickness of 40 mils to 140 mils. In some embodiments, the second layer 64 has a thickness of 40 mils to 130 mils. In some embodiments, the second layer 64 has a thickness of 40 mils to 120 mils. In some embodiments, the second layer 64 has a thickness of 40 mils to 110 mils. In some embodiments, the second layer 64 has a thickness of 40 mils to 100 mils. In some embodiments, the second layer 64 has a thickness of 40 mils to 90 mils. In some embodiments, the second layer 64 has a thickness of 40 mils to 80 mils. In some embodiments, the second layer 64 has a thickness of 40 mils to 70 mils. In some embodiments, the second layer 64 has a thickness of 40 mils to 60 mils.

In some embodiments, the second layer 64 has a thickness of 60 mils to 200 mils. In some embodiments, the second layer 64 has a thickness of 60 mils to 190 mils. In some embodiments, the second layer 64 has a thickness of 60 mils to 180 mils. In some embodiments, the second layer 64 has a thickness of 60 mils to 170 mils. In some embodiments, the second layer 64 has a thickness of 60 mils to 160 mils. In some embodiments, the second layer 64 has a thickness of 60 mils to 150 mils. In some embodiments, the second layer 64 has a thickness of 60 mils to 140 mils. In some embodiments, the second layer 64 has a thickness of 60 mils to 130 mils. In some embodiments, the second layer 64 has a thickness of 60 mils to 120 mils. In some embodiments, the second layer 64 has a thickness of 60 mils to 110 mils. In some embodiments, the second layer 64 has a thickness of 60 mils to 100 mils. In some embodiments, the second layer 64 has a thickness of 60 mils to 90 mils. In some embodiments, the second layer 64 has a thickness of 60 mils to 80 mils. In some embodiments, the second layer 64 has a thickness of 60 mils to 70 mils. In some embodiments, the second layer 64 has a thickness of 80 mils to 200 mils. In some embodiments, the second layer 64 has a thickness of 80 mils to 190 mils. In some embodiments, the second layer 64 has a thickness of 80 mils to 180 mils. In some embodiments, the second layer 64 has a thickness of 80 mils to 170 mils. In some embodiments, the second layer 64 has a thickness of 80 mils to 160 mils. In some embodiments, the second layer 64 has a thickness of 80 mils to 150 mils. In some embodiments, the second layer 64 has a thickness of 80 mils to 140 mils. In some embodiments, the second layer 64 has a thickness of 80 mils to 130 mils. In some embodiments, the second layer 64 has a thickness of 80 mils to 120 mils. In some embodiments, the second layer 64 has a thickness of 80 mils to 110 mils. In some embodiments, the second layer 64 has a thickness of 80 mils to 100 mils. In some embodiments, the second layer 64 has a thickness of 80 mils to 90 mils.

In some embodiments, the second layer 64 has a thickness of 100 mils to 200 mils. In some embodiments, the second layer 64 has a thickness of 100 mils to 190 mils. In some embodiments, the second layer 64 has a thickness of 100 mils to 180 mils. In some embodiments, the second layer 64 has a thickness of 100 mils to 170 mils. In some embodiments, the second layer 64 has a thickness of 100 mils to 160 mils. In some embodiments, the second layer 64 has a thickness of 100 mils to 150 mils. In some embodiments, the second layer 64 has a thickness of 100 mils to 140 mils. In some embodiments, the second layer 64 has a thickness of 100 mils to 130 mils. In some embodiments, the second layer 64 has a thickness of 100 mils to 120 mils. In some embodiments, the second layer 64 has a thickness of 100 mils to 110 mils. In some embodiments, the second layer 64 has a thickness of 120 mils to 200 mils. In some embodiments, the second layer 64 has a thickness of 120 mils to 190 mils. In some embodiments, the second layer 64 has a thickness of 120 mils to 180 mils. In some embodiments, the second layer 64 has a thickness of 120 mils to 170 mils. In some embodiments, the second layer 64 has a thickness of 120 mils to 160 mils. In some embodiments, the second layer 64 has a thickness of 120 mils to 150 mils. In some embodiments, the second layer 64 has a thickness of 120 mils to 140 mils. In some embodiments, the second layer 64 has a thickness of 120 mils to 130 mils.

In some embodiments, the second layer 64 has a thickness of 140 mils to 200 mils. In some embodiments, the second layer 64 has a thickness of 140 mils to 190 mils. In some embodiments, the second layer 64 has a thickness of 140 mils to 180 mils. In some embodiments, the second layer 64 has a thickness of 140 mils to 170 mils. In some embodiments, the second layer 64 has a thickness of 140 mils to 160 mils. In some embodiments, the second layer 64 has a thickness of 140 mils to 150 mils. In some embodiments, the second layer 64 has a thickness of 160 mils to 200 mils. In some embodiments, the second layer 64 has a thickness of 160 mils to 190 mils. In some embodiments, the second layer 64 has a thickness of 160 mils to 180 mils. In some embodiments, the second layer 64 has a thickness of 160 mils to 170 mils. In some embodiments, the second layer 64 has a thickness of 180 mils to 200 mils. In some embodiments, the second layer 64 has a thickness of 180 mils to 190 mils.

In some embodiments, the second layer 64 has a thickness of 25 mils. In some embodiments, the second layer 64 has a thickness of 30 mils. In some embodiments, the second layer 64 has a thickness of 40 mils. In some embodiments, the second layer 64 has a thickness of 50 mils. In some embodiments, the second layer 64 has a thickness of 60 mils. In some embodiments, the second layer 64 has a thickness of 70 mils. In some embodiments, the second layer 64 has a thickness of 80 mils. In some embodiments, the second layer 64 has a thickness of 90 mils. In some embodiments, the second layer 64 has a thickness of 100 mils. In some embodiments, the second layer 64 has a thickness of 110 mils. In some embodiments, the second layer 64 has a thickness of 120 mils. In some embodiments, the second layer 64 has a thickness of 130 mils. In some embodiments, the second layer 64 has a thickness of 140 mils. In some embodiments, the second layer 64 has a thickness of 150 mils. In some embodiments, the second layer 64 has a thickness of 160 mils. In some embodiments, the second layer 64 has a thickness of 170 mils. In some embodiments, the second layer 64 has a thickness of 180 mils. In some embodiments, the second layer 64 has a thickness of 190 mils. In some embodiments, the second layer 64 has a thickness of 200 mils.

In some embodiments, the roofing shingle 60 is textured. In some embodiments, the roofing shingle 60 is textured to impart an appearance of a traditional asphalt roofing shingle. In some embodiments, the first layer 62 includes a first surface 66. In some embodiments, first surface 66 is embossed. In some embodiments, the first surface 66 includes a plurality of indentations. In some embodiments, the plurality of indentations includes a plurality of channels. In some embodiments, the plurality of channels is formed in a pattern. In some embodiments, each of the plurality of channels is random in size, shape and location. In some embodiments, the first surface 66 includes a matte surface texture. In some embodiments, the first surface 66 includes a glossy surface.

In some embodiments, the first surface 66 of the first layer 62 is textured. In some embodiments, the first surface 66 of the first layer 62 is textured by embossing. In some embodiments, the first surface 66 of the first layer 62 is textured. In some embodiments, the first surface 66 of the first layer 62 is textured by molding. In some embodiments, the first surface 66 of the first layer 62 is textured. In some embodiments, the first surface 66 of the first layer 62 is textured by etching. In some embodiments, the first surface 66 of the first layer 62 is textured. In some embodiments, the first surface 66 of the first layer 62 is textured by laser surface texturing.

In some embodiments, a pattern is printed on a first surface 66 of the first layer 62. In some embodiments, a pattern or depiction of solar cells is printed on the first surface 66 of the first layer 62. In some embodiments, the pattern or depiction of solar cells includes a depiction of a plurality of solar cell fingers. In some embodiments, the pattern is printed on the first surface 66 of the first layer 62 by ink jet printing. In some embodiments, the pattern is printed on the first surface 66 of the first layer 62 by laser printing. In some embodiments, the pattern is printed on the first surface 66 of the first layer 62 by lithography. In some embodiments, the pattern is printed on the first surface 66 of the first layer 62 by lithography. In some embodiments, the pattern is printed on the first surface 66 of the first layer 62 by offset printing. In some embodiments, the pattern is printed on the first surface 66 of the first layer 62 by screen printing. In some embodiments, the pattern is printed on the first surface 66 of the first layer 62 by digital printing. In another embodiment, the first layer 62 is painted. In another embodiment, the first layer 62 is a colored layer. In another embodiment, the first layer 62 includes a black color. In some embodiments, the color of the first layer 62 includes a mixture of colors. In some embodiments, the first layer 62 includes an infrared reflective pigment. In some embodiments, the infrared reflective pigment includes graphene. In some embodiments, the roofing shingle 60 meets standards of California Building Energy Efficiency Standards of Residential and Nonresidential Buildings, Title 24, Part 6. In some embodiments, the first surface 66 of the first layer 62 is textured and includes a pattern printed thereon.

In some embodiments, the roofing shingle 60 is configured to be a component of a photovoltaic system that includes a fire resistance that conforms to standards under UL 790/ASTM E 108 test standards. In some embodiments, the roofing shingle 60 includes a Class A rating when tested in accordance with UL 790/ASTM E 108.

In some embodiments, the roofing shingle 60 includes a structure, composition, components, and/or function similar to those of one or more embodiments of the roofing shingles disclosed in U.S. application Ser. No. 17/831,307, filed Jun. 2, 2022, titled “Roofing Module System,” and published under U.S. Patent Application Publication No. 2022-0393637 on Dec. 8, 2022; and/or U.S. application Ser. No. 18/169,718, filed Feb. 15, 2023, titled “Roofing Module System,” and published under U.S. Patent Application Publication No. 2023-0203815 on Jun. 29, 2023, the contents of each of which are incorporated by reference herein in its entirety.

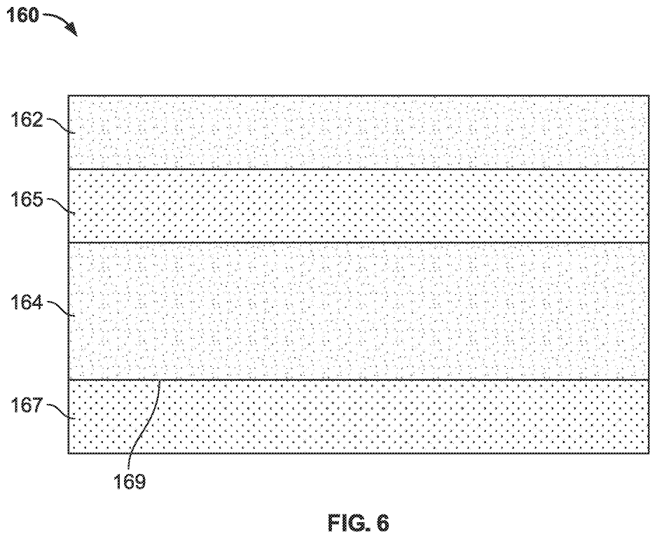

FIG. 6 illustrates some embodiments of a roofing shingle 160. The roofing shingle 160 has a structure and function similar to those of the roofing shingle 60 with certain differences. In some embodiments, the roofing shingle 160 includes a first layer 162, a second layer 164, and a third layer 165. In some embodiments, the third layer 165 is between the first layer 162 and the second layer 164. In some embodiments, the first layer 162 is composed of a polymer. In some embodiments, the first layer 162 is composed of thermoplastic polyolefin (TPO). In some embodiments, the first layer 162 has a thickness of 25 mils to 100 mils. In some embodiments, the first layer 162 has a structure, composition and/or function similar to embodiments of the first layer 62. In some embodiments, the second layer 164 is composed of a polymer. In some embodiments, the second layer 164 is composed of thermoplastic polyolefin (TPO). In some embodiments, the second layer 164 has a thickness of 25 mils to 200 mils. In some embodiments, the second layer 164 has a structure, composition and/or function similar to embodiments of the second layer 64.

In some embodiments, the third layer 165 is composed of a continuous fiber thermoplastic composite tape (CFT). In some embodiments, the third layer 165 is composed of a polypropylene (PP) continuous fiber, unidirectional reinforced thermoplastic composite tape (CFT). In some embodiments, the third layer 165 is composed of a polyethylene terephthalate (PET) continuous fiber, unidirectional reinforced thermoplastic composite tape (CFT). In some embodiments, the third layer 165 is composed of a polyamide (PA) continuous fiber, unidirectional reinforced thermoplastic composite tape (CFT).

In some embodiments, the third layer 165 has a thickness of 25 mils to 200 mils. In some embodiments, the third layer 165 has a thickness of 50 mils to 200 mils. In some embodiments, the third layer 165 has a thickness of 75 mils to 200 mils. In some embodiments, the third layer 165 has a thickness of 100 mils to 200 mils. In some embodiments, the third layer 165 has a thickness of 125 mils to 200 mils. In some embodiments, the third layer 165 has a thickness of 150 mils to 200 mils. In some embodiments, the third layer 165 has a thickness of 175 mils to 200 mils. In some embodiments, the third layer 165 has a thickness of 25 mils to 175 mils. In some embodiments, the third layer 165 has a thickness of 50 mils to 175 mils. In some embodiments, the third layer 165 has a thickness of 75 mils to 175 mils. In some embodiments, the third layer 165 has a thickness of 100 mils to 175 mils. In some embodiments, the third layer 165 has a thickness of 125 mils to 175 mils. In some embodiments, the third layer 165 has a thickness of 150 mils to 175 mils. In some embodiments, the third layer 165 has a thickness of 25 mils to 150 mils. In some embodiments, the third layer 165 has a thickness of 50 mils to 150 mils. In some embodiments, the third layer 165 has a thickness of 75 mils to 150 mils. In some embodiments, the third layer 165 has a thickness of 100 mils to 150 mils. In some embodiments, the third layer 165 has a thickness of 125 mils to 150 mils.

In some embodiments, the third layer 165 has a thickness of 25 mils to 125 mils. In some embodiments, the third layer 165 has a thickness of 50 mils to 125 mils. In some embodiments, the third layer 165 has a thickness of 75 mils to 125 mils. In some embodiments, the third layer 165 has a thickness of 100 mils to 125 mils. In some embodiments, the third layer 165 has a thickness of 25 mils to 125 mils. In some embodiments, the third layer 165 has a thickness of 50 mils to 125 mils. In some embodiments, the third layer 165 has a thickness of 75 mils to 125 mils. In some embodiments, the third layer 165 has a thickness of 25 mils to 100 mils. In some embodiments, the third layer 165 has a thickness of 50 mils to 100 mils. In some embodiments, the third layer 165 has a thickness of 75 mils to 100 mils. In some embodiments, the third layer 165 has a thickness of 25 mils to 75 mils. In some embodiments, the third layer 165 has a thickness of 50 mils to 75 mils. In some embodiments, the third layer 165 has a thickness of 25 mils to 50 mils.

In some embodiments, the roofing shingle 160 includes a fourth layer 167. In some embodiments, the fourth layer 167 is juxtaposed with a lower surface 169 of the second layer 164. In some embodiments, the fourth layer 167 is a lower surface of the roofing shingle 160 when installed on a roof deck. In some embodiments, the fourth layer 167 is composed of a continuous fiber thermoplastic composite tape (CFT). In some embodiments, the fourth layer 167 is composed of a polypropylene (PP) continuous fiber, unidirectional reinforced thermoplastic composite tape (CFT). In some embodiments, the fourth layer 167 is composed of a polyethylene terephthalate (PET) continuous fiber, unidirectional reinforced thermoplastic composite tape (CFT). In some embodiments, the fourth layer 167 is composed of a polyamide (PA) continuous fiber, unidirectional reinforced thermoplastic composite tape (CFT). In some embodiments, the fourth layer 167 has a thickness of 25 mils to 200 mils. In some embodiments, the fourth layer 167 has a thickness in ranges similar to those described above for the third layer 165.

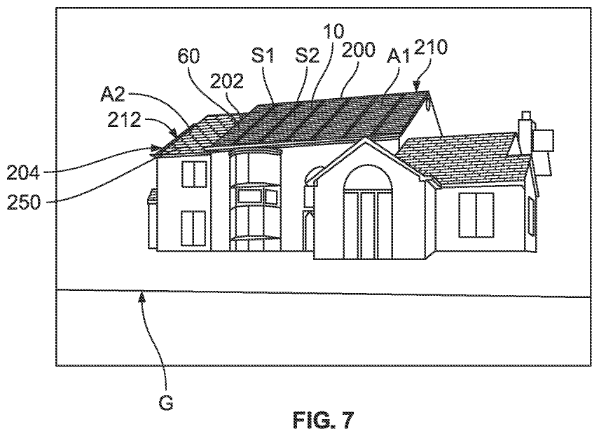

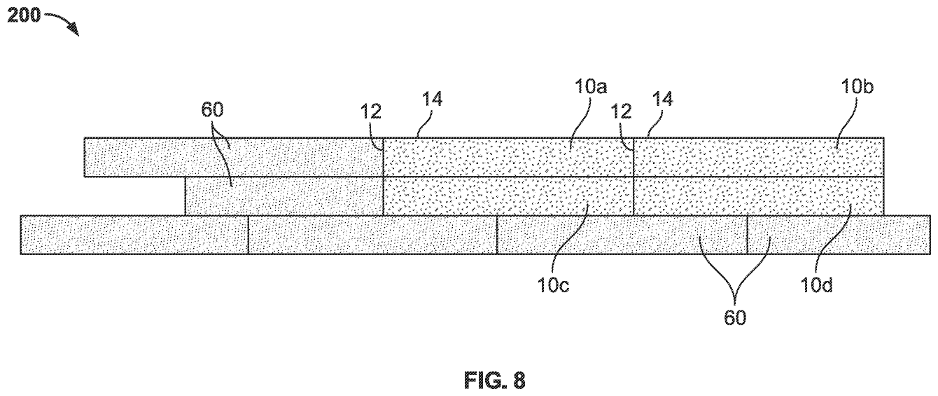

Referring to FIG. 7, in some embodiments, the photovoltaic module 10 is configured to be a component of a roofing system 200 installed on a roof deck 202 of a structure 204. In some embodiments, the structure 204 is a residential structure. In some embodiments, the structure 204 is a residential house. In some embodiments, the structure 204 is a commercial structure. In some embodiments, the photovoltaic modules 10 are arranged in an array on the roof deck 202. In some embodiments, the array of the photovoltaic modules 10 includes a plurality of subarrays. In some embodiments, the array includes at least two subarrays S1, S2. In some embodiments, the array includes more than two subarrays. In some embodiments, the array includes a single array. In some embodiments, each of the subarrays S1, S2 includes a plurality of rows of the photovoltaic modules 10.

In some embodiments, the first side lap 22 of one of the photovoltaic modules 10 in the subarray S2 overlays the second side lap 24 of an adjacent another one of the photovoltaic modules 10 in the subarray S1 in the same one of the rows. In some embodiments, the reveal portion 18 of one of the photovoltaic modules 10 in a subarray S1 overlays the headlap portion 16 of an adjacent another one of the photovoltaic modules 10 of the subarray S1. In some embodiments, the reveal portion 18 of one of the photovoltaic modules 10 in a subarray S2 overlays the headlap portion 16 of an adjacent another one of the photovoltaic modules 10 of the subarray S2.

Referring to FIG. 8, in some embodiments, a first photovoltaic module 10a of the plurality of photovoltaic modules 10 is horizontally adjacent to a second photovoltaic module 10b of the plurality of photovoltaic modules 10. In some embodiments, a third photovoltaic module 10c of the plurality of photovoltaic modules 10 is vertically adjacent to the first photovoltaic module 10a. In some embodiments, a fourth photovoltaic module 10d of the plurality of photovoltaic modules 10 is horizontally adjacent to the third photovoltaic module 10c of the plurality of photovoltaic modules 10. In some embodiments, the fourth photovoltaic module 10d is vertically adjacent to the second photovoltaic module 10b.

In some embodiments, the first ends 12 of the first photovoltaic module 10a and the third photovoltaic module 10c are aligned with each other. In some embodiments, the second ends 14 of the first photovoltaic module 10a and the third photovoltaic module 10c are aligned with each other. In some embodiments, the first ends 12 of the first photovoltaic module 10a and the third photovoltaic module 10c are substantially aligned with each other. In some embodiments, the second ends 14 of the first photovoltaic module 10a and the third photovoltaic module 10c are substantially aligned with each other.

In some embodiments, the first ends 12 of the second photovoltaic module 10b and the fourth photovoltaic module 10d are aligned with each other. In some embodiments, the second ends 14 of the second photovoltaic module 10b and the fourth photovoltaic module 10d are aligned with each other. In some embodiments, the first ends 12 of the second photovoltaic module 10b and the fourth photovoltaic module 10d are substantially aligned with each other. In some embodiments, the second ends 14 of the second photovoltaic module 10b and the fourth photovoltaic module 10d are substantially aligned with each other.

In some embodiments, the first photovoltaic module 10a overlays at least a part of the headlap portion 16 of the third photovoltaic module 10c. In some embodiments, the reveal portion 18 of the first photovoltaic module 10a overlays at least a part of the headlap portion 16 of the third photovoltaic module 10c. In some embodiments, the reveal portion 18 of the first photovoltaic module 10a overlays a substantial portion of the headlap portion 16 of the third photovoltaic module 10c. In some embodiments, the second photovoltaic module 10b overlays at least a part of the headlap portion 16 of the fourth photovoltaic module 10d. In some embodiments, the reveal portion 18 of the second photovoltaic module 10b overlays at least a part of the headlap portion 16 of the fourth photovoltaic module 10d. In some embodiments, the reveal portion 18 of the second photovoltaic module 10b overlays a substantial portion of the headlap portion 16 of the fourth photovoltaic module 10d.

In some embodiments, the second photovoltaic module 10b overlays at least a part of the first photovoltaic module 10a. In some embodiments, the second photovoltaic module 10b overlays at least a part of the second side lap 24 of the first photovoltaic module 10a. In some embodiments, the first side lap 22 of the second photovoltaic module 10b overlays at least a part of the second side lap 24 of the first photovoltaic module 10a. In some embodiments, the fourth photovoltaic module 10d overlays at least a part of the third photovoltaic module 10c. In some embodiments, the fourth photovoltaic module 10d overlays at least a part of the second side lap 24 of the third photovoltaic module 10c. In some embodiments, the first side lap 22 of the fourth photovoltaic module 10d overlays at least a part of the second side lap 24 of the third photovoltaic module 10c. In some embodiments, it is understood that more than the photovoltaic modules 10a, 10b, 10c, 10d may be installed in the columns and rows of the subarrays S1, S2 in a similar manner as described herein.

Referring back to FIG. 7, in some embodiments, a plurality of the roofing shingles 60 is installed on the roof deck 202. In some embodiments, the plurality of roofing shingles 60 is installed proximate to the plurality of photovoltaic modules 10. In some embodiments, the roof deck 202 is a steep slope roof deck. As defined herein, a “steep slope roof deck” is any roof deck that is disposed on a roof having a pitch of Y/X, where Y and X are in a ratio of 4:12 to 12:12, where Y corresponds to the “rise” of the roof, and where X corresponds to the “run” of the roof. In some embodiments, the roof deck 202 includes a plurality of sloped roof planes. In some embodiments, the plurality of roof planes includes a first roof plane 210. In some embodiments, the first roof plane 210 includes a first surface area A1. In some embodiments, the plurality of roof planes includes a second roof plane 212. In some embodiments, the second roof plane 212 includes a second surface area A2. In some embodiments, the second roof plane 212 is different from the first roof plane 210. In some embodiments, the first roof plane 210 extends in a first direction. In some embodiments, the second roof plane 212 extends in a second direction. In some embodiments, the first direction is different than the second direction. In some embodiments, the first direction is substantially similar to the second direction. In some embodiments, the first direction is the same as the first direction.

In some embodiments, the photovoltaic modules 10 are installed on the first roof plane 210. In some embodiments, the photovoltaic modules 10 is installed on the first surface area A1 of the first roof plane 210. In some embodiments, the plurality of roofing shingles 60 is installed on the first surface area A1 of the first roof plane 210. In some embodiments, the plurality of photovoltaic modules 10 and the first plurality of roofing shingles 60 are installed on substantially an entirety of the first surface area A1 of the first roof plane 210. In some embodiments, the plurality of roofing shingles 60 is installed proximate to the plurality of photovoltaic modules 10. In some embodiments, an appearance of the plurality of roofing shingles 60 aesthetically matches an appearance of the plurality of photovoltaic modules 10 when viewed from a vantage point located at a ground level G of the structure 204.

In some embodiments, the roofing system 200 includes a plurality of roofing shingles 250. In some embodiments, the plurality of roofing shingles 250 is installed on the second surface area A2 of the second roof plane 212. In some embodiments, an appearance of the plurality of roofing shingles 250 aesthetically matches an appearance of the plurality of photovoltaic modules 10 and an appearance of the plurality of roofing shingles 60 when viewed from the vantage point located at the ground level G of the structure 204.

In some embodiments, each of the plurality of roofing shingles 250 is an asphalt roofing shingle. In some embodiments, each of the plurality of roofing shingles 250 is a non-asphalt roofing shingle. In some embodiments, each of the plurality of roofing shingles 250 is tile roofing shingle. In some embodiments, each of the plurality of roofing shingles 250 is composed of metal. In some embodiments, each of the plurality of roofing shingles 250 is composed of sheet metal. In some embodiments, each of the plurality of roofing shingles 250 is composed of zinc, copper, aluminum, stainless steel, galvanized steel, or painted or otherwise coated steel. In some embodiments, each of the plurality of roofing shingles 250 is composed of a sandwich composite material. In some embodiments, each of the plurality of roofing shingles 250 is composed of vibration damped steel. In some embodiments, each of the plurality of roofing shingles 250 is composed of polymer film and sheet composites. In some embodiments, each of the plurality of roofing shingles 250 is composed of a polymers. In some embodiments, each of the plurality of roofing shingles 250 is composed of rubber. In some embodiments, each of the plurality of roofing shingles 250 includes a structure, composition, components, and/or function similar to those of one or more embodiments of the roofing shingles and panels disclosed in U.S. Pat. No. 11,603,660 to Anderson et al., titled “Steep Slope Roofing Panel System and Method,” issued Mar. 14, 2023, the disclosure of which is incorporated by reference herein in its entirety.

In some embodiments, each of the plurality of roofing shingles 250 is composed of a waterproof material. In some embodiments, each of the plurality of roofing shingles 250 is composed of at least one of a the)-formable polymer, metal, foam, structural insulated panel materials, or combinations thereof. In some embodiments, each of the plurality of roofing shingles 250 include water shedding features. In some embodiments, the water shedding features can be built into a base of the shingles 250, as part of a frame for the shingles 250, or formed as part of a waterproofing layer applied to the base of the shingles 250, or which can be configured as a roofing shingle 250. In some embodiments, the roofing shingles 250 may be installed in overlapping courses along a roof with water shedding features applied thereto or incorporated along one or more peripheral edges. In some embodiments, each of the plurality of roofing shingles 250 includes a structure, composition, components, and/or function similar to those of one or more embodiments of the roofing shingles and panels disclosed in U.S. Pat. No. 11,566,426 to Boss et al., titled “Roofing Panels with Water Shedding Features,” issued Jan. 31, 2023, the disclosure of which is incorporated by reference herein in its entirety.

In some embodiments, the plurality of roofing shingles 250 may be composed of one or more of the roofing shingle materials, compositions and/or structures, or combinations thereof, as described above. For example, in some embodiments, the plurality of roofing shingles 250 may include asphalt roofing shingles and non-asphalt tile roofing shingles. In some embodiments, the plurality of roofing shingles 250 may include asphalt roofing shingles, non-asphalt tile roofing shingles, and metal roofing shingles.

In some embodiments, a method comprises the steps of:
installing the plurality of photovoltaic modules 10 on the roof deck 202, wherein the plurality of photovoltaic modules 10 is installed on the first surface area A1 of the first roof plane 210;
installing the plurality of roofing shingles 60 on the first surface area A1 of the first roof plane 210; and
installing the plurality of roofing shingles 250 on the second surface area A2 of the second roof plane 212.

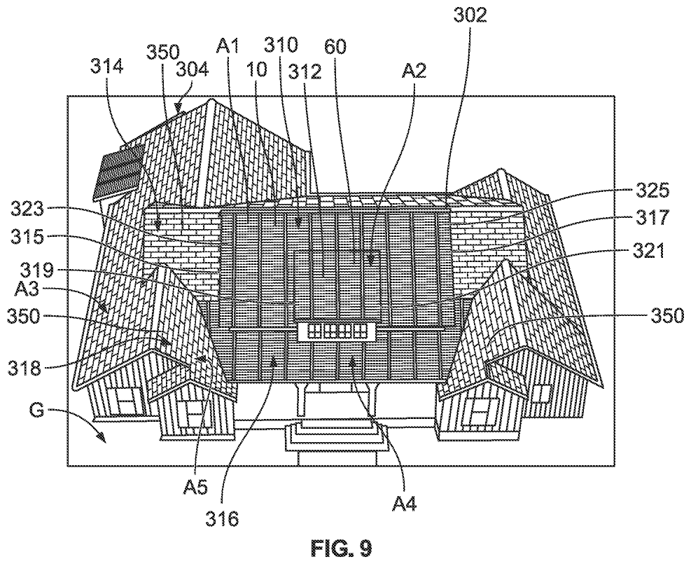

Referring to FIG. 9, in some embodiments, a roof deck 302 of a structure 304 includes a plurality of roof planes. In some embodiments, the plurality of roof planes includes a first roof plane 310. In some embodiments, the first roof plane 310 includes a first surface area A1. In some embodiments, the plurality of roof planes includes a second roof plane 312. In some embodiments, the second roof plane 312 includes a second surface area A2. In some embodiments, the second roof plane 312 is different from the first roof plane 310. In some embodiments, the first roof plane 310 extends in a first direction. In some embodiments, the second roof plane 312 extends in a second direction. In some embodiments, the first direction is different than the second direction. In some embodiments, the first direction is substantially similar to the second direction. In some embodiments, the first direction is the same as the first direction.

In some embodiments, the plurality of photovoltaic modules 10 is installed on the first roof plane 310. In some embodiments, the plurality of photovoltaic modules 10 is installed on the first surface area A1 of the first roof plane 310. In some embodiments, the plurality of roofing shingles 60 is installed on the second roof plane 312. In some embodiments, the plurality of roofing shingles 60 is installed on the second surface area A2 of the second roof plane 312. In some embodiments, the plurality of photovoltaic modules 10 is installed on substantially an entirety of the first surface area A1 of the first roof plane 310. In some embodiments, the plurality of roofing shingles 60 is installed on substantially an entirety of the second surface area A2 of the second roof plane 312. In some embodiments, the first roof plane 310 is located proximate to the second roof plane 312. In some embodiments, the first roof plane 310 is located distal from the second roof plane 312. In some embodiments, an appearance of the plurality of roofing shingles 60 aesthetically matches an appearance of the plurality of photovoltaic modules 10 when viewed from a vantage point located at a ground level G of the structure 304.

In some embodiments, the roof deck 302 includes a third roof plane 314. In some embodiments, the third roof plane 314 includes a third surface area A3. In some embodiments, the third roof plane 314 is different from the first roof plane 310. In some embodiments, the third roof plane 314 is different from the second roof plane 312. In some embodiments, the third roof plane 314 extends in a third direction. In some embodiments, the third direction is different than the first direction of the first roof plane 310. In some embodiments, the third direction is substantially the same as the first direction of the first roof plane 310. In some embodiments, the third direction is equal to the first direction of the first roof plane 310. In some embodiments, the third direction is different than the second direction of the second roof plane 312. In some embodiments, the third direction is substantially the same as the second direction of the second roof plane 312. In some embodiments, the third direction is equal to the second direction of the second roof plane 312.

In some embodiments, a plurality of roofing shingles 350 is installed on the third roof plane 314. In some embodiments, the plurality of roofing shingles 350 is installed on the third surface area A3 of the third roof plane 314. In some embodiments, the plurality of roofing shingles 350 is installed on substantially an entirety of the third surface area A3 of the third roof plane 314. In some embodiments, the plurality of roof planes includes more than the first, second and third roof planes 310, 312, 314. In some embodiments, the plurality of roof planes includes at least a fourth roof plane 316. In some embodiments, a second plurality of the photovoltaic modules 10 is installed on the fourth roof plane 316. In some embodiments, a second plurality of the roofing shingles 60 is installed on the fourth roof plane 316. In some embodiments, a second plurality of the roofing shingles 60 and a second plurality of the photovoltaic modules 10 is installed on the fourth roof plane 316. In some embodiments, a second plurality of the roofing shingles 350 is installed on the fourth roof plane 316.

In some embodiments, the plurality of roof planes includes at least a fifth roof plane 318. In some embodiments, a second plurality of roofing shingles 350 is installed on the fifth roof plane 318. In some embodiments, the roof deck 302 includes additional roof planes having a plurality of roofing shingles 350 installed thereon.

In some embodiments, each of the plurality of roofing shingles 350 is an asphalt roofing shingle. In some embodiments, each of the plurality of roofing shingles 350 is a non-asphalt roofing shingle. In some embodiments, each of the plurality of roofing shingles 350 is tile roofing shingle. In some embodiments, each of the plurality of roofing shingles 350 is composed of metal. In some embodiments, each of the plurality of roofing shingles 350 is composed of sheet metal. In some embodiments, each of the plurality of roofing shingles 350 is composed of zinc, copper, aluminum, stainless steel, galvanized steel, or painted or otherwise coated steel. In some embodiments, each of the plurality of roofing shingles 350 is composed of a sandwich composite material. In some embodiments, each of the plurality of roofing shingles 350 is composed of vibration damped steel. In some embodiments, each of the plurality of roofing shingles 350 is composed of polymer film and sheet composites. In some embodiments, each of the plurality of roofing shingles 350 is composed of a polymers. In some embodiments, each of the plurality of roofing shingles 350 is composed of rubber. In some embodiments, each of the plurality of roofing shingles 350 includes a structure, composition, components, and/or function similar to those of one or more embodiments of the roofing shingles and panels disclosed in U.S. Pat. No. 11,603,660 to Anderson et al., titled “Steep Slope Roofing Panel System and Method,” issued Mar. 14, 2023, the disclosure of which is incorporated by reference herein in its entirety.

In some embodiments, each of the plurality of roofing shingles 350 is composed of a waterproof material. In some embodiments, each of the plurality of roofing shingles 350 is composed of at least one of a the thermo-formable polymer, metal, foam, structural insulated panel materials, or combinations thereof. In some embodiments, each of the plurality of roofing shingles 350 include water shedding features. In some embodiments, the water shedding features can be built into a base of the shingles 350, as part of a frame for the shingles 350, or formed as part of a waterproofing layer applied to the base of the shingles 350, or which can be configured as a roofing shingle 350. In some embodiments, the roofing shingles 350 may be installed in overlapping courses along a roof with water shedding features applied thereto or incorporated along one or more peripheral edges. In some embodiments, each of the plurality of roofing shingles 350 includes a structure, composition, components, and/or function similar to those of one or more embodiments of the roofing shingles and panels disclosed in U.S. Pat. No. 11,566,426 to Boss et al., titled “Roofing Panels with Water Shedding Features,” issued Jan. 31, 2023, the disclosure of which is incorporated by reference herein in its entirety.

In some embodiments, the plurality of roofing shingles 350 may be composed of one or more of the roofing shingle materials, compositions and/or structures, or combinations thereof, as described above. For example, in some embodiments, the plurality of roofing shingles 350 may include asphalt roofing shingles and non-asphalt tile roofing shingles. In some embodiments, the plurality of roofing shingles 350 may include asphalt roofing shingles, non-asphalt tile roofing shingles, and metal roofing shingles.

In some embodiments, the first roof plane 310 is located at a first elevation. In some embodiments, the first elevation is measured relative to the ground level. In some embodiments, the second roof plane 312 is located at a second elevation. In some embodiments, the second elevation is measured relative to the ground level. In some embodiments, the first elevation is different than the second elevation.

In some embodiments, the first roof plane 310 includes a first edge 315 and a second edge 317 opposite the first edge 315. In some embodiments, the second roof plane 312 includes a first edge 319 and a second edge 321 opposite the first edge 319. In some embodiments, the first edge 315 of the first roof plane 310 is substantially parallel with the first edge 319 of the second roof plane 312. In some embodiments, the first edge 315 of the first roof plane 310 is parallel with the first edge 319 of the second roof plane 312. In some embodiments, the second edge 317 of the first roof plane 310 is substantially parallel with the second edge 321 of the second roof plane 312. In some embodiments, the second edge 317 of the first roof plane 310 is parallel with the second edge 321 of the second roof plane 312. In some embodiments, the first edge 315 of the first roof plane 310 is substantially aligned with the first edge 319 of the second roof plane 312. In some embodiments, the first edge 315 of the first roof plane 310 is aligned with the first edge 319 of the second roof plane 312. In some embodiment, the second edge 317 of the first roof plane 310 is substantially aligned with the second edge 321 of the second roof plane 312. In some embodiments, the second edge 317 of the first roof plane 310 is aligned with the second edge 321 of the second roof plane 312. In some embodiments, the first edge 315 of the first roof plane 310 is offset from the first edge 319 of the second roof plane 312. In some embodiments, the first edge 315 of the first roof plane 310 is offset laterally from the first edge 319 of the second roof plane 312. In some embodiments, the first edge 315 of the first roof plane 310 is offset vertically from the first edge 319 of the second roof plane 312. In some embodiments, the second edge 317 of the first roof plane 310 is offset from the second edge 321 of the second roof plane 312. In some embodiments, the second edge 317 of the first roof plane 310 is offset laterally from the second edge 321 of the second roof plane 312. In some embodiments, the second edge 317 of the first roof plane 310 is offset vertically from the second edge 321 of the second roof plane 312. In some embodiments, the first edge 315 of the first roof plane 310 is oblique relative to the first edge 319 of the second roof plane 312. In some embodiments, the second edge 317 of the first roof plane 310 is oblique relative to the second edge 321 of the second roof plane 312.

In some embodiments, a first section 323 of the first roof plane 312 is located proximate to the first edge 315. In some embodiments, a second section 325 of the first roof plane 312 is located proximate to the second edge 317.

In some embodiments, one or more of the first section 323 and the second section 325 includes a plurality of the roofing shingles 60. In some embodiments, one or more of the first section 323 and the second section 325 includes a plurality of the roofing shingles 350. In some embodiments, the roofing shingles 350 may be composed of one or more of the materials, compositions and/or structures as described above, for example, asphalt roofing shingles, non-asphalt tile roofing shingles, metal roofing shingles, etc. In some embodiments, one or more of the first section 323 and the second section 325 includes a plurality of the roofing shingles 60 and a plurality of the roofing shingles 350.

In some embodiments, a method comprises the steps of:
installing the plurality of photovoltaic modules 10 on the roof deck 302, 302, wherein the plurality of photovoltaic modules 10 is installed on the first surface area A1 of the first roof plane 310;
installing the plurality of roofing shingles 60 on the second surface area A2 of the second roof plane 312; and
installing the plurality of roofing shingles 350 on the third surface area A3 of the third roof plane 314.

What is claimed is:

1. A system, comprising:
a roof deck,
wherein the roof deck includes a plurality of sloped roof planes,
wherein the plurality of sloped roof planes includes
a first roof plane,
wherein the first roof plane includes a first surface area, and
a second roof plane,
wherein the second roof plane includes a second surface area,
wherein the second roof plane is different from the first roof plane, and
a third roof plane,
wherein the third roof plane includes a third surface area,
wherein the third roof plane is different from the first roof plane and the second roof plane;
a plurality of photovoltaic modules installed on the first surface area of the first roof plane;
a plurality of first roofing shingles,
wherein each of the plurality of first roofing shingles does not include a solar cell,
wherein each of the plurality of first roofing shingles is composed of at least a first material,
wherein the plurality of first roofing shingles is installed on the second surface area of the second roof plane; and
a plurality of second roofing shingles,
wherein each of the plurality of second roofing shingles is composed of at least a second material, wherein the second material is different from the first material, and
wherein the plurality of second roofing shingles is installed on the third surface area of the third roof plane.

2. The system of claim 1, wherein an appearance of the plurality of first roofing shingles aesthetically matches an appearance of the plurality of photovoltaic modules when viewed from a vantage point located at a ground level of a structure comprising the roof deck, and wherein an appearance of the plurality of second roofing shingles aesthetically matches the appearance of the plurality of first roofing shingles and the appearance of the plurality of photovoltaic modules when viewed from the vantage point.

3. The system of claim 1, wherein the plurality of photovoltaic modules is installed on substantially an entirety of the first surface area of the first roof plane, and wherein the plurality of first roofing shingles is installed on substantially an entirety of the second surface area of the second roof plane.

4. The system of claim 1, wherein each of the plurality of first roofing shingles includes
a first layer,
wherein the first layer includes
a first surface, and
a second surface opposite the first surface,
wherein the first surface is textured, and
a second layer,
wherein the second layer is below the second surface of the first layer.

5. The system of claim 4, wherein each of the plurality of photovoltaic modules includes
at least one solar cell,
an encapsulant encapsulating the at least one solar cell,
wherein the encapsulant of the photovoltaic module includes a first surface and a second surface opposite the first surface of the encapsulant of the photovoltaic module,
a frontsheet,
wherein the frontsheet includes
a first surface, and
a second surface opposite the first surface of the frontsheet,
wherein the second surface of the frontsheet is juxtaposed with the first surface of the encapsulant, and
a backsheet juxtaposed with the second surface of the encapsulant of the photovoltaic module.

6. The system of claim 5, wherein the first surface of the frontsheet is textured.

7. The system of claim 6, wherein each of the first layer and the second layer is composed of a polymer.

8. The system of claim 7, wherein each of the first layer and the second layer is composed of thermoplastic polyolefin (TPO).

9. The system of claim 4, wherein each of the first layer and the second layer includes continuous fiber thermoplastic composite tape (CFT).

10. The system of claim 4, wherein the first layer has a thickness of 25 mils to 100 mils.

11. The system of claim 10, wherein the second layer has a thickness of 25 mils to 200 mils.

12. The system of claim 4, wherein the first layer includes a pattern printed on the first surface of the first layer.

13. The system of claim 12, wherein the pattern is a depiction of solar cells.

14. The system of claim 1, wherein the first roof plane is located at a first elevation, wherein the first elevation is measured relative to a ground level of a structure comprising the roof deck, and wherein the second roof plane is located at a second elevation, wherein the second elevation is measured relative to the ground level, and wherein the first elevation is different than the second elevation.

15. The system of claim 14, wherein the first roof plane includes a first edge and a second edge opposite the first edge, wherein the second roof plane includes a first edge and a second edge opposite the first edge of the second roof plane, wherein the first edge of the first roof plane is substantially parallel with the first edge of the second roof plane, and wherein the second edge of the first roof plane is substantially parallel with the second edge of the second roof plane.

16. The system of claim 14, wherein the first roof plane includes a first edge and a second edge opposite the first edge, wherein the second roof plane includes a first edge and a second edge opposite the first edge of the second roof plane, wherein the first edge of the first roof plane is oblique relative to the first edge of the second roof plane, and wherein the second edge of the first roof plane is oblique relative to the second edge of the second roof plane.

17. The system of claim 1, wherein the first material is asphalt, metal, a polymer or rubber.

18. The system of claim 17, wherein the second material is asphalt, metal, a polymer or rubber.

19. A system, comprising:
a roof deck,
wherein the roof deck includes a plurality of sloped roof planes, wherein the plurality of sloped roof planes includes
a first roof plane,
wherein the first roof plane includes a first surface area, and
a second roof plane,
wherein the second roof plane includes a second surface area,
wherein the second roof plane is different from the first roof plane;
a plurality of photovoltaic modules installed on the first surface area of the first roof plane;
a plurality of first roofing shingles,
wherein each of the plurality of first roofing shingles does not include a solar cell,
wherein each of the plurality of first roofing shingles is composed of at least a first material,
wherein the plurality of first roofing shingles is installed on the first surface area of the first roof plane; and
a plurality of second roofing shingles,
wherein each of the plurality of second roofing shingles is composed of a second material,
wherein the second material is different than the first material, and
wherein the plurality of second roofing shingles is installed on the second surface area of the second roof plane.

20. A method, comprising:
installing a plurality of photovoltaic modules on a roof deck,
wherein the roof deck includes a plurality of sloped roof planes, wherein the plurality of sloped roof planes includes
a first roof plane,
wherein the first roof plane includes a first surface area, and
a second roof plane,
wherein the second roof plane includes a second surface area,
wherein the second roof plane is different from the first roof plane, and a third roof plane,
wherein the third roof plane includes a third surface area,
wherein the third roof plane is different from the first roof plane and the second roof plane,
wherein the plurality of photovoltaic modules is installed on the first surface area of the first roof plane;
installing a plurality of first roofing shingles on the second surface area of the second roof plane,
wherein each of the plurality of first roofing shingles does not include a solar cell
wherein each of the plurality of first roofing shingles is composed of at least a first material; and
installing a plurality of second roofing shingles on the third surface area of the third roof plane,
wherein each of the plurality of second roofing shingles is composed of at least a second material, and
wherein the second material is different than the first material.
